(19) United States
(12) Patent Application Publication
(10) Pub. No.: US 2024/0176324 A1
(43) Pub. Date: May 30, 2024

(54) METHODS AND INTERNET OF THINGS SYSTEMS FOR MONITORING THE RELIABILITY OF SELF-CLOSING VALVES FOR SMART GAS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei HE, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 18/436,065

(22) Filed: Feb. 8, 2024

(30) Foreign Application Priority Data
Jan. 16, 2024 (CN) 202410064945.3

(51) Int. Cl. G05B 19/406

(52) U.S. Cl. CPC G05B 19/406; G05B 2219/37371

(57) ABSTRACT

Embodiments of the present disclosure disclose a method for monitoring the reliability of a self-closing valve for smart gas, the method comprising: obtaining, in response to the gas self-closing valve being closed, operating environment data in a first preset time and gas usage information of a gas user in the first preset time; determining a closure type of the gas self-closing valve based on the gas usage information and a setting position of the gas self-closing valve; in response to the closure type being the first type, issuing an adjustment prompt; and in response to the closure type being the second type, determining a reliability of a current closure state of the gas self-closing valve, and determining whether to issue an alert prompt based on the reliability.

### CROSS-REFERENCE TO RELATED APPLICATIONS

This application claims priority to Chinese Patent Application No. CN 202410064945.3, filed on Jan. 16, 2024, the entire contents of which are hereby incorporated by reference.

### TECHNICAL FIELD

The present disclosure relates to the field of gas safety monitoring, and in particular to a method and an Internet of Things (IoT) system for monitoring the reliability of a self-closing valve for smart gas.

### BACKGROUND

A gas self-closing valve is a valve used to control and cut off the flow of gas. In the event of gas leakage, fire, explosion and other dangerous situations, the gas self-closing valve is capable of quickly cutting off a gas supply under manual operation or automatic control. Cutting off the gas supply effectively prevents backflow of gas in a pipeline, i.e., prevents unlit gas from flowing back into the gas supply pipeline, thus safeguarding the safety and reliability of the gas system.

However, the gas self-closing valve is inevitably subject to problems during its use. Monitoring whether the gas self-closing valve is in normal operating condition is usually determined by conducting regular on-site inspections and maintenance of the gas self-closing valve. This approach is labor intensive and does not allow for timely detection of abnormal operating conditions of the gas self-closing valve.

Therefore, it is desired to provide a method and an Internet of Things (IoT) system for monitoring the reliability of a self-closing valve for smart gas to monitor an operation state of the gas self-closing valve in a timely and effective manner, and to safeguard a stable operation of a gas pipeline network.

### SUMMARY

In order to solve the problem of how to effectively and accurately monitor an operation state of a gas self-closing valve, the present disclosure provides a method and an Internet of Things (IoT) system and a storage medium for monitoring the reliability of a smart gas self-closing valve.

The present disclosure comprises a method for monitoring the reliability of a self-closing valve for smart gas, the method comprises: obtaining, in response to the gas self-closing valve being closed, operating environment data in a first preset time and gas usage information of a gas user in the first preset time; determining a closure type of the gas self-closing valve based on the gas usage information and a setting position of the gas self-closing valve, the closure type including a first type and a second type, the first type being related to the gas usage situation, and the second type being related to a gas supply situation; in response to the closure type being the first type, issuing an adjustment prompt; and in response to the closure type being the second type, determining a reliability of a current closure state of the gas self-closing valve based at least on the operating environment data, and determining whether to issue an alert prompt based on the reliability.

The present disclosure comprises a IoT system for monitoring the reliability of a self-closing valve for smart gas, the IoT system comprises a smart gas user platform, a smart gas service platform, a smart gas equipment management platform, a smart gas sensing network platform, and a smart gas object platform; the smart gas equipment management platform being configured to: obtain, in response to the gas self-closing valve being closed, operating environment data in a first preset time and gas usage information of a gas user in the first preset time; determine a closure type of the gas self-closing valve based on the gas usage information and a setting position of the gas self-closing valve, the closure type including a first type and a second type, the first type being related to the gas usage situation, and the second type being related to a gas supply situation; in response to the closure type being the first type, issue an adjustment prompt; and in response to the closure type being the second type, determine a reliability of a current closure state of the gas self-closing valve based at least on the operating environment data, and determine whether to issue an alert prompt based on the reliability.

The present disclosure comprises a non-transitory computer-readable storage medium, comprising a set of instructions, wherein when the computer reads the computer instructions in the storage medium, the method for monitoring the reliability of a self-closing valve for smart gas is implemented.

The beneficial effects brought about by the above-described invention include, but are not limited to: (1) a specific closure type of the gas self-closing valve may be accurately determined by the gas usage information and the setting position of the gas self-closing valve; (2) when the closure type of the gas self-closing valve is the first type, adjustment information may be sent to the gas user in time to prevent the gas user from being unable to use the gas or gas leakage due to mis-operation or improper use; when the closure type is the second type, an alert may be sent to a manager in time to effectively improve the management efficiency and service quality of the manager.

### BRIEF DESCRIPTION OF THE DRAWINGS

FIG. 1 is an exemplary platform structural diagram illustrating an IoT system for monitoring the reliability of a gas self-closing valve for smart gas according to some embodiments of the present disclosure;

FIG. 2 is an exemplary flowchart illustrating a method for monitoring the reliability of a gas self-closing valve for smart gas according to some embodiments of the present disclosure;

FIG. 3 is an exemplary schematic diagram illustrating a process for determining whether to issue a first alert prompt according to some embodiments of the present disclosure; and

FIG. 4 is an exemplary schematic diagram illustrating a process for determining whether to issue a second alert prompt according to some embodiments of the present disclosure.

### DETAILED DESCRIPTION

The technical schemes of embodiments of the present disclosure will be more clearly described below, and the accompanying drawings need to be configured in the description of the embodiments will be briefly described below. Obviously, the drawings in the following description are merely some examples or embodiments of the present disclosure, and will be applied to other similar scenarios according to these accompanying drawings without paying creative labor. Unless obviously obtained from the context or the context illustrates otherwise, the same numeral in the drawings refers to the same structure or operation.

It should be understood that the “system”, “device”, “unit” and/or “module” used herein is a method for distinguishing different components, elements, parts or assemblies of different levels. However, if other words may achieve the same purpose, the words may be replaced by other expressions.

As shown in the present disclosure and claims, unless the context clearly prompts the exception, “a”, “one”, and/or “the” is not specifically singular, and the plural may be included. It will be further understood that the terms “comprise,” “comprises,” and/or “comprising,” “include,” “includes,” and/or “including,” when used in present disclosure, specify the presence of stated features, integers, steps, operations, elements, and/or components, but do not preclude the presence or addition of one or more other features, integers, steps, operations, elements, components, and/or groups thereof.

The flowcharts are used in present disclosure to illustrate the operations performed by the system according to the embodiment of the present disclosure. It should be understood that the preceding or following operations is not necessarily performed in order to accurately. Instead, the operations may be processed in reverse order or simultaneously. Moreover, one or more other operations may be added to the flowcharts. One or more operations may be removed from the flowcharts.

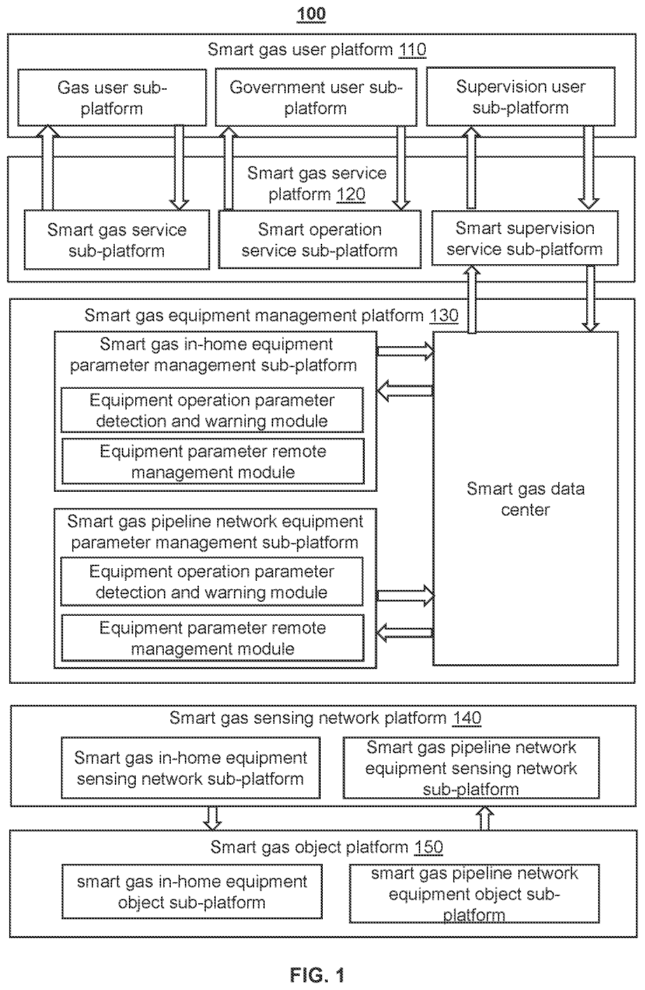

FIG. 1 is an exemplary platform structural diagram illustrating an IoT system for monitoring the reliability of a gas self-closing valve for smart gas according to some embodiments of the present disclosure.

As shown in FIG. 1, an Internet of Things (IoT) system 100 for monitoring the reliability of a smart gas self-closing valve includes a smart gas user platform 110, a smart gas service platform 120, a smart gas equipment management platform 130, a smart gas sensing network platform 140, and a smart gas object platform 150 interacting in sequence.

The smart gas user platform 110 is a platform for interacting with a user. In some embodiments, the smart gas user platform 110 may be configured as a terminal device. In some embodiments, the smart gas user platform may include a gas user sub-platform, a government user sub-platform, and a supervision user sub-platform. The gas user sub-platform is a platform that provides gas-related data and solutions to gas problems for gas users. The gas user may be an industrial gas user, a commercial gas user, an ordinary gas user, and so on. The government user sub-platform is a platform that provides gas operation related data for government users. The government user may be a manager of a gas operation entity (e.g., a manager of an administration department) and so on. The supervision user sub-platform may be a platform for supervision users to supervise the operation of the entire IoT system. The supervision user may be a person from a safety management department.

In some embodiments, the smart gas user platform 110 may send a query command of gas equipment usage data to the smart gas equipment management platform 130 via the smart gas service platform 120, and receive a gas equipment management program (e.g., an adjustment prompt, an alert prompt, etc.) uploaded by the smart gas service platform 120.

The smart gas service platform 120 is a platform for receiving and transmitting data and/or information. In some embodiments, the smart gas service platform 120 may receive a query command sent by the smart gas user platform 110 and send the query command to the smart gas equipment management platform 130. In some embodiments, the smart gas service platform 120 may send a gas equipment management program to the smart gas user platform 110.

In some embodiments, the smart gas service platform may include a smart gas use service sub-platform, a smart operation service sub-platform, and a smart supervision service sub-platform. The smart gas use service sub-platform is a platform for providing the gas users with gas use services. The smart operation service sub-platform is a platform that provides the government users with gas operation related information (e.g., gas equipment management information, etc.). The smart supervision service sub-platform is a platform to provide supervision needs for the supervision users.

The smart gas equipment management platform 130 may be a platform that coordinates and harmonizes the connection and collaboration between various functional platforms, aggregates all information of the IoT, and provides perception management and control management functions for the IoT operation system.

In some embodiments, the smart gas equipment management platform 130 may include a smart gas in-home equipment parameter management sub-platform, a smart gas pipeline network equipment parameter management sub-platform, and a smart gas data center.

The smart gas data center may aggregate and store at least a portion of operating data of the IoT system. In some embodiments, the smart gas equipment management platform 130 may interact with the smart gas service platform 120 and the smart gas sensing network platform 140 via the smart gas data center. In some embodiments, the smart gas data center may issue a query command of gas equipment usage data to the smart gas sensing network platform 140, and receive relevant data of the gas equipment uploaded by the smart gas sensing network platform 140.

In some embodiments, the smart gas in-home equipment parameter management sub-platform, and the smart gas pipeline network equipment parameter management sub-platform may interact with the smart gas data center in both directions, respectively.

In some embodiments, the smart gas in-home equipment parameter management sub-platform, and the smart gas pipeline network equipment parameter management sub-platform may include an equipment operation parameter detection and warning module, and an equipment parameter remote management module, respectively.

The equipment operation parameter detection and warning module may be used to view historical and real-time equipment operation parameters and carry out monitoring and warning according to a preset threshold. When the equipment operation parameter is abnormal (e.g., exceeding a corresponding preset threshold), the manager may switch directly from the equipment operation parameter detection and warning module into the equipment parameter remote management module to remotely process the equipment parameter. If necessary, the smart gas service platform 120 is used to send an adjustment prompts and/or an alert prompt to the user.

The equipment parameter remote management module may remotely set and adjust the equipment parameter of the smart gas object platform 150, and remotely authorize an adjustment of the equipment parameter initiated on-site by the smart gas object platform 150.

The smart gas sensing network platform 140 is a functional platform that manages sensing communications. In some embodiments, the smart gas sensing network platform 140 may be configured as a communication network and gateway to perform functions such as network management, protocol management, command management, and data parsing.

In some embodiments, the smart gas sensing network platform 140 may include a smart gas in-home equipment sensing network sub-platform and a smart gas pipeline network equipment sensing network sub-platform.

The smart gas object platform 150 may be a functional platform for perceptual information generation and control information execution. For example, the smart gas object platform 150 may monitor and obtain information about an operation of a gas device (e.g., a gas self-closing valve).

In some embodiments, the smart gas object platform 150 may include a smart gas in-home equipment object sub-platform and a smart gas pipeline network equipment object sub-platform. The smart gas in-home equipment object sub-platform may be configured as various types of gas in-home equipment of the gas users. The smart gas pipeline network equipment object sub-platform may be configured as various types of gas pipeline network equipment and monitoring equipment.

In some embodiments, the smart gas object platform 150 may send operation information of the gas equipment to the smart gas equipment management platform 130 via the smart gas sensing network platform 140.

Some embodiments of the present disclosure, based on the IoT system 100 for monitoring the reliability of a self-closing valve for smart gas, a closed loop of information operation may be formed between the smart gas object platform and the smart gas user platform, and operate in a coordinated and regular manner under the unified management of the smart gas equipment management platform, realizing gas equipment management informatization and intelligence.

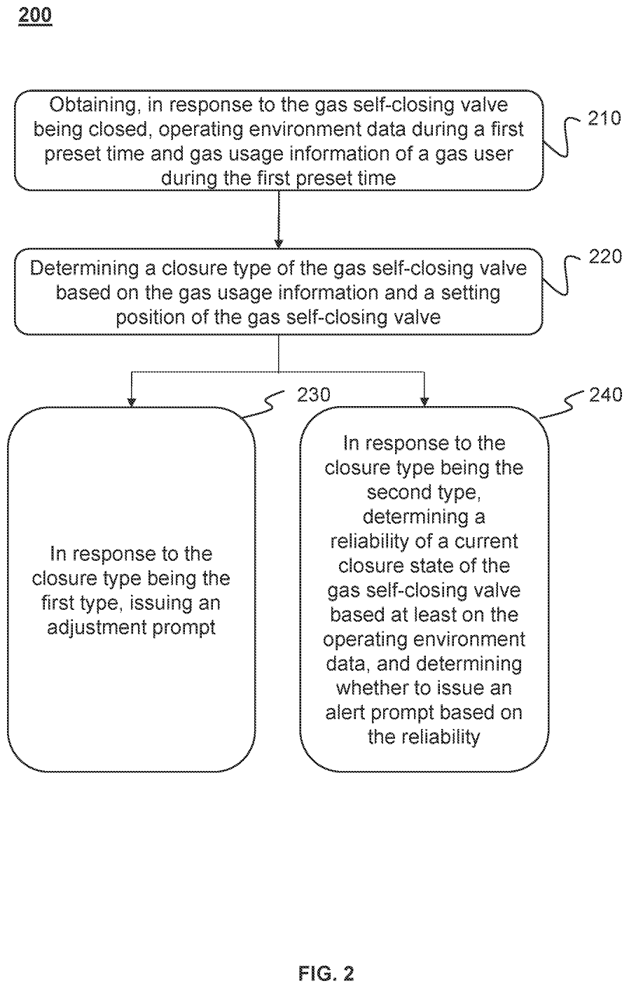

FIG. 2 is an exemplary flowchart illustrating a method for monitoring the reliability of a gas self-closing valve for smart gas according to some embodiments of the present disclosure. In some embodiments, a process 200 may be performed by the smart gas equipment management platform 130. As shown in FIG. 2, the process 200 includes the following steps.

Step 210, obtaining, in response to the gas self-closing valve being closed, operating environment data in a first preset time and gas usage information of a gas user in the first preset time.

The first preset time is a period of time before the gas self-closing valve closes. The first preset time may be preset by a system or a human being, etc.

The operating environment data is data information related to an environment in which the gas self-closing valve is located. In some embodiments, the operating environment data includes a pressure, a flow rate, a temperature, a humidity, etc., of the gas. In some embodiments, the smart gas equipment management platform 130 may obtain the operating environment data of the gas self-closing valve in real time via a perceptual element and store the data in a storage device of the smart gas data center. The smart gas equipment management platform 130 may obtain the operating environment data in the first preset time through data interaction with the storage device.

The perceptual element is an element that is used to sense, measure, or detect a specific parameter or signal in the environment. In some embodiments, the perceptual element includes a pressure sensor, a flow rate sensor, a temperature sensor, a humidity sensor, etc.

The gas usage information is data information related to gas usage by a gas user. In some embodiments, the gas usage information includes gas meter battery power, user's gas remaining cost, and power status of critical gas equipment. The gas meter is a device that is connected to the gas self-closing valve and is used to monitor gas consumption and to measure usage. The critical gas equipment is equipment that is required for gas usage monitoring. The critical gas equipment may be determined by preset. For example, a water heater, a gas stove, etc. Insufficient power to the gas meter battery and the critical gas equipment may cause the gas self-closing valve to close. Correspondingly, the power status of the critical gas equipment may include whether the water heater is insufficiently powered, whether the gas stove is insufficiently powered, etc. The insufficient power may mean that a power value is less than a preset power threshold.

It should be noted that when the critical gas equipment is a gas cooker that does not require battery power for ignition, the power status of the critical gas equipment does not include a power status of the gas cooker.

The smart gas equipment management platform 130 may obtain the gas usage information in the first preset time through the data interaction with the storage device.

Step 220, determining a closure type of the gas self-closing valve based on the gas usage information and a setting position of the gas self-closing valve.

In some embodiments, the setting position of the gas self-closing valve may include a user position and a non-user position.

The non-user position means that the gas self-closing valve is set on a communal gas pipeline. For example, the communal gas pipeline includes a gas pipeline that supplies gas to an entire high-rise building, a gas pipeline that supplies gas to a neighborhood, or the like. The gas self-closing valve provided at the non-user position may be used to control a gas supply to a downstream gas pipeline.

The user position is an installation position other than the non-user position. For example, a non-communal gas pipeline includes a gas pipeline that enters the home of a single gas user, a gas pipeline that supplies gas to critical gas equipment of a gas user, a position in the vicinity of critical gas equipment, or the like. The gas self-closing valve provided at the user position may be used to control the gas supply to the gas pipeline of the individual gas user.

The closure type may be used to categorize the reason or circumstances under which the gas self-closing valve is closed. In some embodiments, the closure type includes a first type and a second type.

The first type is a type of the gas self-closing valve being closed caused the gas user. In some embodiments, the first type is related to a gas usage situation. For example, the first type may be a type of gas self-closing valve being closed due to insufficient current in the gas meter, insufficient gas arrears, and insufficient battery power in the gas cooker. When the gas meter is insufficiently powered, the gas meter is unable to function properly and provide real-time data, which may trigger the gas self-closing valve to close a protection mechanism to prevent the inability to monitor and measure the gas usage. The gas supplier may take measures to interrupt the gas supply if the gas is in arrears for a long period of time. In this case, the gas supply may be cut off by operating the gas self-closing valve in order to force the gas user to fulfill the obligation to pay the outstanding bill. When the gas cooker battery is insufficiently powered, an ignition device may not function properly, resulting in failure to ignite the gas. In this case, the protection mechanism of the gas self-closing valve may be triggered to prevent gas leakage.

The second type refers to a type of the gas self-closing valve being closed caused the gas supplier. In some embodiments, the second type is related to a gas supply situation. For example, the second type may be a type of the gas self-closing valve being closed due to the gas leakage.

In some embodiments, the smart gas equipment management platform 130 may determine the closure type of the gas self-closing valve based on the gas usage information and the setting position of the gas self-closing valve by a preset determination rule. For example, the preset determination rule may be that: when the gas usage information indicates that the critical gas equipment is sufficiently powered, and the setting position of the gas self-closing valve is the user position, the closure type is determined to be the first type. For example, the preset determination rule may be that: when the gas usage information shows that the user's gas remaining cost is insufficient (i.e., the remaining cost is 0 or a negative number), and the setting position of the gas self-closing valve is the user position, the closure type is determined to be the first type. As another example, the preset determination rule may be that: when the gas usage information shows that the gas meter battery is insufficiently powered and the setting position of the gas self-closing valve is the user position, the closure type is determined to be the first type. As another example, the preset determination rule may be that: when the gas usage information shows that the gas meter battery is sufficiently powered, the critical gas equipment is sufficiently powered, the user's gas remaining cost is sufficient (i.e., the remaining cost is greater than 0), and the gas self-closing valve is set at the non-user position, the closure type is determined to be the second type.

In some embodiments, the smart gas equipment management platform 130 may determine the closure type of the gas self-closing valve based on the setting position of the gas self-closing valve.

In some embodiments, in response to the setting position as the non-user position, the smart gas equipment management platform 130 may determine the closure type to be the second type.

In some embodiments, in response to the setting position to be the user position, the smart gas equipment management platform 130 may determine whether the gas usage information satisfies a preset condition; in response to satisfying the preset condition, determine the closure type to be the first type; and in response to not satisfying the preset condition, determine the closure type to be the second type.

The preset condition is a condition used to determine whether the closure type is the first or second type.

In some embodiments, the preset condition may be that: the gas meter battery power is below a preset power threshold. In some embodiments, the preset condition may be that: the user's gas remaining cost is less than a preset cost threshold. In some embodiments, the preset condition may be that: the power of the critical gas equipment is below the preset power threshold. The preset power thresholds corresponding to different types of gas equipment may be different, depending on an actual situation.

In some embodiments, when any one or more of the above-described preset condition appear in the gas usage information, the smart gas equipment management platform 130 may determine that the gas usage information satisfies the preset condition, so as to determine that the closure type of the gas self-closing valve is a first type. Conversely, the gas usage information is determined not to satisfy the preset condition, and the closure type of the gas self-closing valve is determined to be the second type. The preset power threshold of the gas meter battery power, the preset cost threshold of the user's gas remaining cost, and the preset power threshold of the power of the critical gas equipment may be preset by the manager based on historical experience.

In some embodiments of the present disclosure, the closure type of the gas self-closing valve may be quickly and accurately determined based on the setting position of the gas self-closing valve and the gas usage information, effectively improving the management efficiency and service quality of the manager.

Step 230, in response to the closure type being the first type, issuing an adjustment prompt.

In some embodiments, the adjustment prompt may be used to prompt the gas user to make an adjustment to the closure type of the gas self-closing valve. For example, the gas user may be prompted to adjust the gas self-closing valve from a closed state to an open state.

In some embodiments, the adjustment prompt may be used to prompt the gas user to make an adjustment to associated gas equipment. For example, the adjustment prompt may include reminding the gas user to replace the battery in the gas meter, reminding the gas user to make the gas payment, reminding the gas user to recharge the critical gas equipment, or the like.

In some embodiments, the smart gas equipment management platform 130 may issue the adjustment prompt in multiple ways. For example, the adjustment prompt is pushed to the gas user via a text message or a mobile app, the adjustment prompt is made via the gas self-closing valve and a LED on the gas equipment, etc. The contents of the above adjustment prompt are for illustrative purposes only and are not intended to limit the scope of the present disclosure.

Step 240, in response to the closure type being the second type, determining a reliability of a current closure state of the gas self-closing valve based at least on the operating environment data, and determining whether to issue an alert prompt based on the reliability.

The reliability of the current closure state refers to how accurately the gas self-closing valve is currently closed. For example, when a gas abnormality occurs, the gas self-closing valve is in the closure state, and at this time, the reliability of the closure state of the gas self-closing valve is considered high. For example, when a gas abnormality does not occur, the gas self-closing valve is in the closure state, at which time the closure state of the gas self-closing valve is considered to have a lower reliability. The gas abnormality includes, but is not limited to, one or more of insufficient battery power of the gas meter, gas arrears, insufficient power of the key gas equipment, gas leakage, etc.

In some embodiments, in response to the closure type being the second type, the smart gas equipment management platform 130 may determine the reliability of the current closure state by querying a preset comparison table based on the operating environment data. In some embodiments, the preset comparison table may include correspondences between different operating environment data and different reliabilities. The preset comparison table may be determined based on historical data or a priori knowledge.

In some embodiments, the reliability of the current closure state may include a perceptual reliability. The perceptual reliability refers to an accuracy of the operating environment data detected by the perceptual element of the gas self-closing valve. The higher the perceptual reliability is, the higher the accuracy of the operating environment data detected by the perceptual element is.

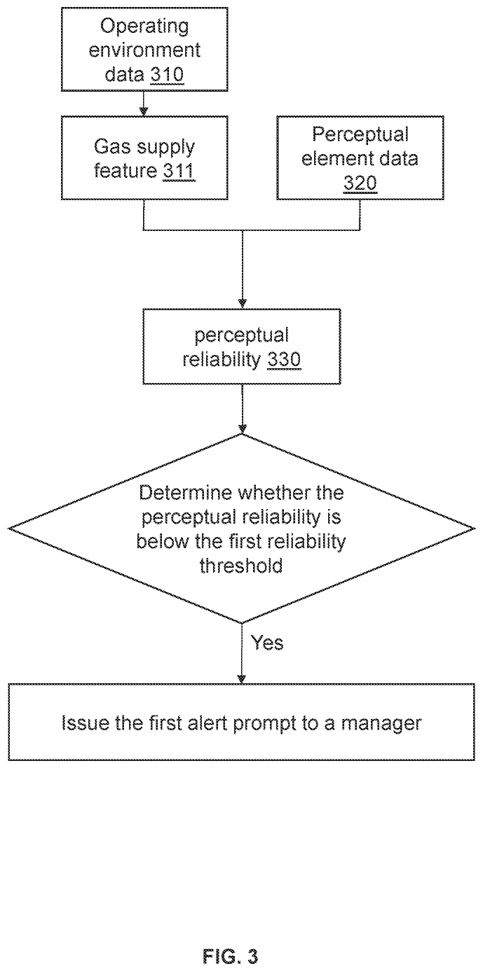

In some embodiments, in response to the closure type being the second type, the smart gas equipment management platform 130 may also determine the gas supply feature based on the operating environment data and further determine the perceptual reliability of the current closure state. For more information on the embodiment, please refer to FIG. 3 and its related description.

In some embodiments, the reliability of the closure type may include an execution reliability. The execution reliability refers to a reliability with which a non-perceptual element of the gas self-closing valve may function properly. The non-perceptual element is an element on the gas self-closing valve that is used to perform a mechanical operation in addition to the perceptual element. For example, the non-perceptual element may include a spring, a bearing, a relay, etc.

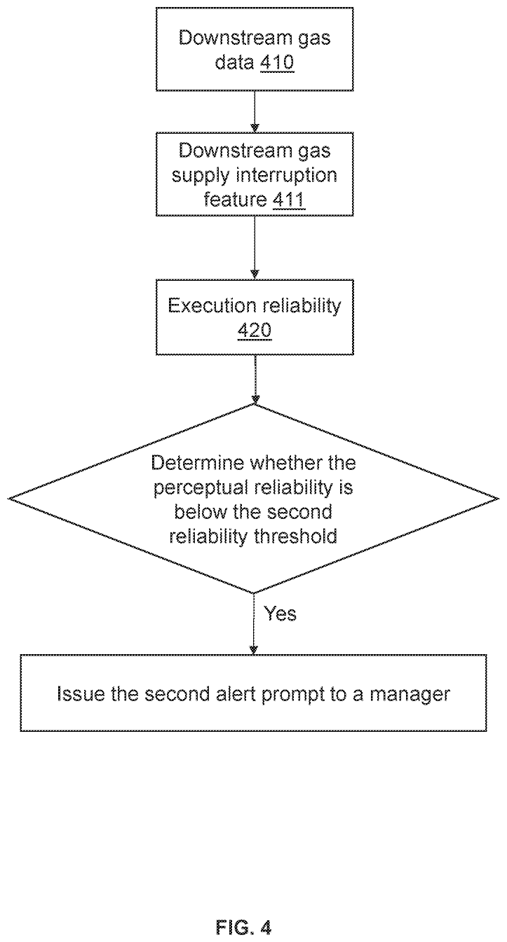

In some embodiments, in response to the closure type being the second type, the smart gas equipment management platform 130 may also determine a downstream gas supply interruption feature based on downstream gas data and further determine the execution reliability of the current closure state. For more information on the embodiment, please refer to FIG. 4 and its related description.

In some embodiments, in response to the reliability of the current closure state being lower than a preset reliability threshold, the smart gas equipment management platform 130 may issue an alert prompt to the manager. For example, prompting methods of the alert prompt include sending the alert prompt to the manager via a text message or a mobile App, displaying the alert prompt on a dashboard at the manager's workplace, etc.

In some embodiments, the alert prompt may include a first alert prompt. The first alert prompt is an alert prompt that is issued based on the perceptual reliability. In some embodiments, in response to the perceptual reliability of the current closure state falling below the first reliability threshold, the smart gas equipment management platform 130 may issue the first alert prompt. The first reliability threshold is a preset reliability threshold for determining whether to issue the first alert prompt. The first reliability threshold may be preset by the manager based on historical experience, etc.

In some embodiments, the alert prompt may include a second alert prompt. The second alert prompt is an alert prompt that is issued based on the execution reliability. In some embodiments, in response to the execution reliability of the current closure state falling below a second reliability threshold, the smart gas equipment management platform 130 may issue the second alert prompt. The second reliability threshold is a preset reliability threshold for determining whether to issue the second alert prompt. The second reliability threshold may be preset by the manager based on historical experience, etc.

In some embodiments, the smart gas equipment management platform 130 may issue the first alert prompt and/or the second alert prompt to the manager. In some embodiments, the smart gas equipment management platform 130 may also issue the first alert prompt and/or the second alert prompt to other components of the IoT system 100 for monitoring the reliability of a gas self-closing valve for smart gas (e.g., the smart gas object platform, etc.) to verify relevant data of various gas equipment. The relevant data may include detection data of the perceptual element, operation records of the gas self-closing valve, etc.

In some embodiments, the prompting methods of the first alert prompt and the second alert prompt may be the same or different. In some embodiments, prompt content of the first alert prompt and the second alert prompt may be the same or different. In some embodiments, the first alert prompt may be related to a failure condition of the perceptual element. For example, the first alert prompt may include a type of perceptual element that has malfunctioned, etc. In some embodiments, the second alert prompt may be related to a failure condition of the gas self-closing valve. For example, the second alert prompt may include that there is a delay in the closure time of the gas self-closing valve, etc.

In some embodiments of the present disclosure, a specific closure type of the gas self-closing valve are capable of being accurately determined based on the gas usage information and the setting position of the gas self-closing valve. When the closure type of the gas self-closing valve is the first type, adjustment information may be sent to the gas user in a timely manner to prevent the gas user from being unable to use gas or gas leakage due to misuse or improper use. When the closure type is the second type, an alert may be sent to the manager in time, effectively improving the management efficiency and service quality of the manager.

FIG. 3 is an exemplary schematic diagram illustrating a process for determining whether to issue a first alert prompt according to some embodiments of the present disclosure.

In some embodiments, in response to the closure type being the second type, the smart gas equipment management platform 130 may determine the perceptual reliability based on the operating environment data and issue the first alert prompt based on an actual situation of the perceptual reliability.

Referring to FIG. 3, in some embodiments, the smart gas equipment management platform 130 may determine a gas supply feature 311 based on operating environment data 310; determine a perceptual reliability 330 of the current closure state based on the gas supply feature 311, and the perceptual element data 320 of the gas self-closing valve; and in response to the perceptual reliability falling below a first reliability threshold, issue a first alert prompt to the manager.

For more information on the perceptual reliability, the first alert prompt, and the first reliability threshold, please refer to FIG. 2 and its related descriptions.

The gas supply feature is a feature associated with the supply of gas over a period of time. For example, the gas supply feature includes a rate of change of pressure, flow rate, temperature, humidity, or the like of the gas supplied over a period of time.

In some embodiments, the smart gas equipment management platform 130 may determine the gas supply feature based on the operating environment data in a first preset time through data analysis. For example, the first preset time is a time interval [t, t+t0], at which time a difference between the operating environment data at the moment of t+t0 and the operating environment data at the moment of t may be determined, and a ratio of the difference to t0 is determined as the gas supply feature.

The perceptual element data is data information associated with the perceptual element. In some embodiments, the perceptual element data includes usage data of the perceptual element and performance data of the perceptual element. The usage data of the perceptual element may include a time of use (a time from factory to current), a number of repairs, or the like. The performance data of the perceptual element may include a sensitivity, a measurement accuracy, a response time, a stability, etc. The sensitivity of the perceptual element refers to a response degree of the perceptual element to an input signal. A higher sensitivity means that the perceptual element is able to more accurately sense and measure subtle changes in the input signal. The measurement accuracy is the closeness between a measurement result and a true value of the perceptual element. The perceptual element with a high measurement accuracy provides more accurate and reliable measurement results. The response time is a time interval between the reception of an input signal by the perceptual element and the generation of a response. The perceptual element with a fast response time is able to sense and respond more quickly to changes in the environment. The stability is the accuracy and consistency of the perceptual element in repeated perceptions.

The perceptual element data may be determined in a variety of ways. In some embodiments, the smart gas equipment management platform 130 may determine the perceptual element data based on feedback from the gas user. By way of example only, the feedback from the gas user that an actual gas usage does not match the gas usage shown by the gas meter indicates that the sensitivity of the perceptual element is low. In some embodiments, the smart gas equipment management platform 130 may determine the performance data of the perceptual element by a testing device. For example, the manager detects the response time of the perceptual element via a signal generator, determines the sensitivity, the measurement accuracy, and the stability of the perceptual element via an oscilloscope, etc. In some embodiments, the perceptual element data is related to the number of repairs and time of use of the perceptual element. For example, the higher the number of repairs is and the longer the usage time is, the worse the performance data of the perceptual element is. In some embodiments, the smart gas equipment management platform 130 may retrieve the usage data of the perceptual element from the storage device. The above description related to the manner of determining the data of the perceptual element is for illustrative purposes only and is not intended to limit the scope of the present disclosure.

In some embodiments, the smart gas equipment management platform 130 may determine the perceptual reliability based on the gas supply feature and the perceptual component data by vector retrieval.

In some embodiments, the smart gas equipment management platform 130 may construct a vector to be matched based on the gas supply feature, and the perceptual element data; perform a vector matching in a vector database based on the vector to be matched to determine an associated feature vector; and determine the perceptual reliability based on the associated feature vector.

In some embodiments, the vector database may include a plurality of reference feature vectors and their corresponding reference perceptual reliabilities. In some embodiments, the reference feature vectors may be constructed based on historical data. For example, the plurality of reference feature vectors are obtained by vector construction of a plurality of historical gas supply characteristics, and historical sensory element data. The reference perceptual reliabilities corresponding to the plurality of reference feature vectors may be labeled by a human being based on a priori knowledge and failure conditions of the perceptual element.

In some embodiments, the smart gas equipment management platform 130 may determine, based on the vector to be matched, a reference feature vector in the vector database that meets a preset matching condition, and determine the reference feature vector that meets the preset matching condition as the associated feature vector. The preset matching condition may refer to a judgment condition for determining the associated feature vector. In some embodiments, the preset matching condition may include a vector distance being less than a distance threshold, a vector distance being minimized, etc.

In some embodiments, a processor may determine a reference perceptual reliability corresponding to the associated feature vector as a current perceptual reliability.

In some embodiments, the smart gas equipment management platform 130 may determine a first perceptual reliability and a second perceptual reliability based on the gas supply feature and the perceptual element data; and determine a perceptual reliability based on the first perceptual reliability and/or the second perceptual reliability.

The first perceptual reliability and the second perceptual reliability are parameters used to determine the perceptual reliability.

In some embodiments, the gas equipment management platform 130 may determine the first perceptual reliability and the second perceptual reliability by vector retrieval based on the gas supply feature, and the perceptual element data. Correspondingly, the vector database described hereinbefore may include a first reference perceptual reliability and a second reference perceptual reliability, as described in more detail in the relevant descriptions described hereinbefore, and is not be repeated herein.

In some embodiments, the first perceptual reliability and the second perceptual reliability may be determined differently.

In some embodiments, the smart gas equipment management platform 130 may determine a first abnormal degree based on the gas supply feature; determine a second abnormal degree based on the perceptual element data; determine a combined abnormal degree based on the first abnormal degree and the second abnormal degree; and determine the first perceptual reliability based on the combined abnormal degree.

The first abnormal degree and the second abnormal degree are both parameters used to measure an abnormal degree of the perceptual element, and are distinguished from each other by the difference in the manner of determination.

In some embodiments, the smart gas equipment management platform 130 may calculate a first similarity between the gas supply feature and a historical gas supply feature at a same time period and at a same position, and determine the first abnormal degree based on the first similarity. For example, the first similarity may be subtracted from the value 1, and a resulting difference may be determined as the first abnormal degree. The first similarity may be determined based on a vector distance between the gas supply feature and the historical gas supply feature. For example, the vector distance may be a Euclidean distance, a Manhattan distance, etc.

In some embodiments, the smart gas equipment management platform 130 may determine a second abnormal degree of the perceptual element by querying an abnormal degree comparison table based on the perceptual element data. In some embodiments, the abnormal degree comparison table may include correspondences between different perceptual element data and different second abnormal degrees. For example, the higher the number of repairs is, the longer the usage time is, and the worse the performance parameter of a particular perceptual element in the perceptual element data is, the higher the second abnormal degree of that perceptual element is. The abnormal degree comparison table may be preset based on historical data or a priori knowledge.

The combined abnormal degree is a parameter that comprehensively measures the abnormal degree of the perceptual element. In some embodiments, the smart gas equipment management platform 130 determines a weighted sum result of the first abnormal degree and the second abnormal degree as the combined abnormal degree.

In some embodiments, the smart gas equipment management platform 130 may assign weighted weights according to a ratio of the first abnormal degree to the second abnormal degree. For example, a total value of the weighted weights corresponding to the first abnormal degree and the second abnormal degree (hereinafter referred to as a total value of a first weight) may be preset, and the weighted weights corresponding to the first abnormal degree and the second abnormal degree may be determined according to the total value of the first weight, and the ratio of the first abnormal degree to the second abnormal degree, respectively. The total value of the first weight may be preset by the system or by a human being.

In some embodiments, the smart gas equipment management platform 130 may determine the first perceptual reliability of the perceptual element by querying a perceptual reliability comparison table based on the combined abnormal degree. In some embodiments, the perceptual reliability comparison table may include correspondences between different combined abnormal degrees and different first perceptual reliabilities. For example, the higher the combined abnormal degree is, the lower the first perceptual reliability is. The perceptual reliability comparison table may be preset based on historical data or a priori knowledge.

In some embodiments of the present disclosure, by determining the first perceptual reliability, the accuracy of the operating environment data detected by the perceptual element may be analyzed at the level of the gas supply feature, and the perceptual element data. Since the combined abnormal degree takes into account the effects of the gas supply feature and the perceptual element data, the first perceptual reliability determined by the combined abnormal degree may effectively improve the accuracy of the first perceptual reliability.

In some embodiments, the smart gas equipment management platform 130 may determine, based on the gas supply feature, the perceptual element data and the operating environment data, a predicted failure rate of the perceptual element of the gas self-closing valve by a failure prediction model; and determine the second perceptual reliability based on the predicted failure rate.

The failure prediction model is a model for predicting the failure rate of the perceptual element. In some embodiments, the failure prediction model is a machine learning model. For example, a deep neural networks (DNN) model, a support vector machine (SVM) model, etc., or any of other customized model structures, etc. or any one or combination thereof.

In some embodiments, inputs to the failure prediction model include the gas supply feature, the perceptual element data, and the operating environment data; and outputs of the failure prediction model include the predicted failure rate of the perceptual element. For more information on the gas supply feature, and the operating environment data, please refer to FIG. 2 and its related description.

The predicted failure rate is a predicted probability that the perceptual element fails.

In some embodiments, the inputs of the failure prediction model further include the downstream gas supply interruption feature. For more information on the downstream gas supply interruption feature, please refer to FIG. 4 and its related description.

In some embodiments of the present disclosure, by further inputting the downstream gas supply interruption feature into the failure prediction model, the influence of gas on the perceptual element from the downstream gas pipeline of the gas self-closing valve is fully and comprehensively considered, so that the predicted failure rate of the perceptual element output from the model is more accurate and reasonable.

In some embodiments, the failure prediction model may be obtained by training a plurality of first training samples with a first label by various methods. For example, a training may be performed based on a gradient descent method. By way of example only, the plurality of first training samples with the first label may be input into an initial fault prediction model, a loss function is constructed from the first label and results of the initial fault prediction model, and parameters of the initial monitoring model are iteratively updated based on the loss function. The model training is completed when the loss function of the initial fault prediction model satisfies a preset condition, and the trained fault prediction model is obtained. The preset condition may be a loss function convergence, a number of iterations reaching a threshold, etc.

In some embodiments, the first training samples may include a sample gas supply feature, sample perceptual element data, sample operating environment data of a sample gas self-closing valve, and the first label may be an actual failure probability of a perceptual element in the sample gas self-closing valve. When an abnormality occurs in the perceptual element in the sample gas self-closing valve, its failure probability is recorded as 1; when no abnormality occurs in the perceptual element in the sample gas self-closing valve, its failure probability is recorded as 0.

In some embodiments, the first training samples may be obtained based on historical operating data of sample gas self-closing valves. The first label may be determined based on whether an abnormality occurs in the perceptual element and a type of abnormality. For example, if a perceptual element corresponding to the at least one first training sample does not have an abnormality, the first label is 0. If the perceptual element corresponding to the at least one first training sample has an abnormality, a value of the first label is determined based on the extent to which the type of abnormality that occurs affects a measurement accuracy of the perceptual element. The greater the degree of influence of the type of abnormality on the measurement accuracy of the perception element is, the closer the value of the first label is to 1. The degree of influence of the type of abnormality of the perception element on the measurement accuracy of the perception element may be preset by the system or by a human being.

In some embodiments, the smart gas equipment management platform 130 may determine the second perceptual reliability based on the predicted failure rate of the perceptual element in a variety of ways. For example, the smart gas equipment management platform 130 may subtract the predicted failure rate from 1 and determine a resulted difference as the second perceptual reliability. As another example, the smart gas equipment management platform 130 may determine the reciprocal of the predicted failure rate as the second perceptual reliability.

In some embodiments of the present disclosure, by determining the second perceptual reliability, the influence of the failure condition of the perceptual element on the accuracy of the operating environment data detected by the perceptual element may be taken into account. Further, by determining the predicted failure rate through the failure prediction model, the self-learning capability of the machine learning model may be utilized to find a law from a large amount of data, to obtain a correlation relationship between the gas supply feature, the perceptual element data, the operating environment data, and the failure rate, to improve the accuracy and efficiency of determining the failure rate, and thus to effectively improve the accuracy of the second perceptual reliability.

In some embodiments, the smart gas equipment management platform 130 may determine the perceptual reliability in a variety of ways based on the first perceptual reliability and/or the second perceptual reliability. In some embodiments, the smart gas equipment management platform 130 may determine the first perceptual reliability as the perceptual reliability. In some embodiments, the smart gas equipment management platform 130 may identify the second perceptual reliability as the perceptual reliability. In some embodiments, the smart gas equipment management platform 130 may determine a weighted result of the first perceptual reliability and the second perceptual reliability as the perceptual reliability. In some embodiments, weighted weights of the first perceptual reliability and the second perceptual reliability may be assigned in accordance with a ratio between the two. In some embodiments, the smart gas equipment management platform 130 may determine a weighted weight corresponding to the second perceptual reliability based on the execution reliability of the current closure state of the gas self-closing valve. For example, the weighted weight corresponding to the second perceptual reliability may be negatively correlated to the execution reliability, and the higher the execution reliability is, the smaller the weighted weight corresponding to the second perceptual reliability is. Further, the smart gas equipment management platform 130 may determine a weighted weight corresponding to the first perceptual reliability based on the weighted weight corresponding to the second perceptual reliability and a total value of the weights of the first perceptual reliability and the weighted weight corresponding to the second perceptual reliability (hereinafter referred to as a total value of a second weight). The total value of the second weight may be preset by the system or by a human being.

In some embodiments of the present disclosure, by determining the perceptual reliability by the first perceptual reliability and/or the second perceptual reliability, the accuracy of the operating environment data detected by the perceptual element may be analyzed in various aspects based on the actual detected gas supply feature, the perceptual element data, and/or the predicted failure rate of the perceptual element, so as to improve the accuracy of the perceptual reliability. By determining the perceptual reliability, and determining whether to issue the first alert prompt based on the perceptual reliability, the manager may determine whether the perceptual element is in a normal operating state based on the perceptual reliability, and carry out a timely warning, which helps to timely maintain the gas self-closing valve, and thus ensure the safety and reliability of the gas supply.

FIG. 4 is an exemplary schematic diagram illustrating a process for determining whether to issue a second alert prompt according to some embodiments of the present disclosure.

In some embodiments, in response to the closure type being the second type, the smart gas equipment management platform 130 may determine the execution reliability and issue the second alert prompt based on the actual condition of the execution reliability.

Referring to FIG. 4, in some embodiments, in response to the closure type being the second type, the smart gas equipment management platform 130 may obtain downstream gas data 410 in a second preset time; determine a downstream gas supply interruption feature 411 based at least on the downstream gas data 410; determine an execution reliability 420 based on the downstream gas supply interruption feature 411; and in response to the execution reliability degree falling below a second reliability threshold, issue a second alert prompt to the manager.

For more information on the execution reliability, the second alert prompt, and the second reliability threshold, please refer to FIG. 2 and its related descriptions.

The second preset time is a period of time after the gas self-closing valve is closed. The second preset time may be preset by the system or by a human.

The downstream gas data is data information related to gas in a downstream gas pipeline. The downstream gas pipeline is located downstream of the gas self-closing valve.

In some embodiments, the downstream gas data includes at least a gas supply volume sequence. The gas supply volume sequence may include gas supply volumes detected at a plurality of time periods in the second preset time. The gas supply volume refers to data related to an amount of gas supplied by the downstream gas pipeline. The gas supply volume may refer to a gas supply volume per unit of time.

In some embodiments, the smart gas equipment management platform 130 may detect the gas supply volume through a gas metering device provided at the downstream gas pipeline. In some embodiments, the smart gas equipment management platform 130 may determine a gas supply per unit of time of the downstream gas pipeline by the following steps S11, step S12.

Step S11, dividing the second preset time into a plurality of time periods in accordance with a preset unit time interval. For example, the second preset time is 20 minutes, and the second preset time is divided into 20 time periods according to a preset unit time interval of 1 minute.

Step S12, determining a unit time gas supply volume of the downstream gas pipeline after the gas self-closing valve is closed, based on the gas metering device that is closest to the gas self-closing valve and is provided on the downstream gas pipeline. For example, if the starting moment of a certain time period is A and the ending moment is B, and the readings of the gas metering device at moments A and B are a and b, respectively, then the unit time gas supply volume is

$$\frac{\vert a - b \vert}{B - A} .$$

The downstream gas supply interruption feature is a feature related to a situation in which gas is supplied from the downstream gas pipeline. In some embodiments, the downstream gas supply interruption feature may include a disconnection time, a disconnection completion, a disconnection speed, etc., of the gas in the downstream gas pipeline.

The disconnection time is a time from the closing of the gas self-closing valve to the time when the gas supply to the downstream gas pipeline is restored to a stable level. For example, if a closure moment of the gas self-closing valve is T1 and a moment when the gas supply to the downstream gas pipeline is restored to stabilization is T2, the disconnection time is T2-T1. The moment when the gas supply returns to stability is the moment when the gas supply per unit of time stabilizes. For example, if a plurality of consecutive time periods occur in which the gas supply per unit of time is the same or similar, the ending moment of the last time period is the moment at which the gas supply per unit of time stabilizes. The number of time periods may be preset by the system or by a human.

The disconnection completion is a completion degree at which the downstream gas pipeline stops supplying gas. In some embodiments, the smart gas equipment management platform 130 may determine the disconnection completion through steps S21 to steps S23 below.

Step S21, dividing the first preset time into a plurality of time periods according to a preset unit time interval. For information on the first preset time, please refer to FIG. 2 and its related description.

Step S22, determining a gas supply per unit of time of the last time period in the first preset time based on the gas metering device closest to the gas self-closing valve and disposed on the downstream gas line.

Step S23, calculating a percentage of the gas supply volume per unit of time that stabilizes after the gas self-closing valve is closed to the gas supply volume per unit of time of the last time period in the first preset time, and a difference obtained by subtracting the percentage from 1 is determined as the disconnection completion. The closer the gas supply per unit of time after the gas self-closing valve is closed to the gas supply per unit of time of the last time period in the first preset time is, the smaller the value of the disconnection completion is, indicating that the downstream gas pipeline stops supplying gas with a higher completion.

The disconnection speed is a rate at which the downstream gas pipeline stops supplying gas during the disconnection time. In some embodiments, the smart gas equipment management platform 130 may determine the disconnection speed by the following formula (1).

$$V = \frac{Q 2 - Q 1}{T 2 - T 1} \times 100 \% \qquad ( 1 )$$

V denotes the disconnection speed; Q1 denotes the gas supply per unit of time that stabilizes after the gas self-closing valve is closed; Q2 denotes the gas supply per unit of time in the last time period in the first preset time before the gas self-closing valve is closed; T1 denotes the closure moment of the gas self-closing valve; and T2 denotes the moment at which the gas supply of the downstream gas pipeline of the gas self-closing valve is restored to a stable level.

In some embodiments, the smart gas equipment management platform 130 may determine the execution reliability by querying an execution reliability comparison table based on a composite difference between a standard downstream gas supply interruption feature and a downstream gas supply interruption feature. In some embodiments, the execution reliability comparison table may include a correspondence between different composite differences and different execution reliabilities. For example, the higher the composite difference is, the lower the execution reliability is, etc. The execution reliability comparison table may be predetermined based on historical data or a priori knowledge.

The standard downstream gas supply interruption feature is a downstream gas supply interruption feature when the non-perceptual element is capable of normal operation. The standard downstream gas supply interruption feature may include a standard disconnection time, a standard disconnection completion, and a standard disconnection speed for the gas in the downstream gas pipeline. In some embodiments, the standard downstream gas supply interruption feature may be preset based on historical experience, historical data.

In some embodiments, the smart gas equipment management platform 130 may determine a disconnection time difference, a disconnection completion difference, and a disconnection speed difference between the standard downstream gas supply interruption feature and the downstream gas supply interruption feature, respectively, and a weighted result of the disconnection time difference, the disconnection completion difference, and the disconnection speed difference, as a composite difference. The weighted weights may be preset by the system, or preset by a human. The disconnection time difference is a difference between the standard disconnection time and the disconnection time; the disconnection completion difference is a difference between the standard disconnection completion and the disconnection completion; and the disconnection speed difference is a difference between the standard disconnection speed and the disconnection speed. The difference is a value of a metric in the downstream gas supply interruption feature that exceeds the value of the corresponding metric in the standard downstream gas supply interruption feature. If the metric in the downstream gas supply interruption feature does not exceed the corresponding metric in the standard downstream gas supply interruption feature, the difference value is 0. The disconnection time difference, for example, is a value by which the disconnection time exceeds the standard disconnection time. If the disconnection time does not exceed the standard disconnection time, the disconnection time difference is zero.

In some embodiments, in response to the execution reliability falling below the second reliability threshold, the smart gas equipment management platform 130 may issue the second alert prompt to the manager.

In some embodiments, the second reliability threshold is related to a criticality of a setting position of the gas self-closing valve. For more information on the setting position, please refer to FIG. 2 and its related description.

The criticality is a parameter used to characterize the importance of the setting position. The higher the criticality is, the more important the setting position of the gas self-closing valve is.

In some embodiments, the criticality of the setting position of the gas self-closing valve is related to a number of downstream gas users, and surrounding equipment data. The number of downstream gas users is a number of gas users corresponding to the downstream gas pipeline of the gas self-closing valve. The surrounding equipment data is data related to equipment surrounding the gas self-closing valve. For example, the surrounding equipment data may include a type of surrounding equipment (e.g., including a gas meter, a gas pressure gauge, etc.), a number of surrounding equipment, and an importance level of the surrounding equipment (which may be set by the system or by a human being in advance based on the use of the equipment). For example, the higher the number of downstream gas users is, the higher the number of surrounding equipment is and the higher the surrounding equipment importance level is, the more critical the setting position is. In some embodiments, the smart gas equipment management platform 130 may obtain the surrounding equipment data by a gas pipeline design map, a user input, etc.

In some embodiments, the higher the criticality of the setting position of the gas self-closing valve is, the greater the second reliability threshold is.

In some embodiments of the present disclosure, for a gas self-closing valve with a high criticality at a setting position, increasing its second reliability threshold is equivalent to strengthening the monitoring of the gas self-closing valve at the setting position so as to provide timely warnings, which is conducive to the reasonable arrangement of the inspection order by the manager, the timely discovery of problems with the gas, and the reduction of the impact on the gas users.

In some embodiments, the second reliability threshold correlates to an overall performance score of the non-perceptual element of the gas self-closing valve.

The overall performance score is a parameter used to assess the overall performance of a plurality of non-perceptual elements. A higher overall performance score indicates a superior overall performance of the plurality of non-perceptual elements.

In some embodiments, the smart gas equipment management platform 130 may determine an overall performance score of the plurality of non-perceptual elements based on individual performance parameters of the plurality of non-perceptual elements. The individual performance parameters are parameters used to assess the performance of a single non-perceptual element, including accuracy, strength, stiffness, and durability of the non-perceptual element.

In some embodiments, the smart gas equipment management platform 130 may determine an individual performance score of a single non-perceptual element based on individual performance parameters of the single non-perceptual element via a score comparison table; and determine an overall performance score of the non-perceptual elements based on the individual performance scores of each of the plurality of non-perceptual elements included in the gas self-closing valve via a weighted approach. In some embodiments, the score comparison table may include correspondences between different individual performance parameters and different individual performance scores. The score comparison table may be preset based on historical data or a priori knowledge.

In some embodiments, the higher the overall performance score of the non-perceptual elements of the gas self-closing valve is, the larger the second reliability threshold is. The higher the overall performance score of the non-perceptual elements is, the better the overall performance of the non-perceptual elements is, indicating the better the disconnection of the gas after the gas self-closing valve is closed, and the less tolerant of a decrease in the execution reliability, at which point increasing the second reliability threshold may strengthen monitoring efforts, detect problems with the gas in a timely manner, and reduce the impact on the gas users.

In some embodiments of the present disclosure, by determining the downstream gas supply disconnection feature through the downstream gas data and determining the execution reliability of the non-perceptual element based on it, the second alert prompt may be accurately and efficiently determined whether to issue to the manager, which enables the manager to carry out the maintenance of the non-perceptual element in a timely manner, and effectively improves the safety and reliability of the gas supply.

Some embodiments of the present disclosure provide a non-transitory computer-readable storage medium, comprising a set of instructions, wherein when the computer reads the computer instructions in the storage medium, the above-described method of monitoring the reliability of a gas self-closing valve is implemented.

The basic concepts have been described above, apparently, in detail, as will be described above, and does not constitute limitations of the disclosure. Although there is no clear explanation here, those skilled in the art may make various modifications, improvements, and modifications of present disclosure. This type of modification, improvement, and corrections are recommended in present disclosure, so the modification, improvement, and the amendment remain in the spirit and scope of the exemplary embodiment of the present disclosure.

At the same time, present disclosure uses specific words to describe the embodiments of the present disclosure. As “one embodiment”, “an embodiment”, and/or “some embodiments” means a certain feature, structure, or characteristic of at least one embodiment of the present disclosure. Therefore, it is emphasized and should be appreciated that two or more references to “an embodiment” or “one embodiment” or “an alternative embodiment” in various parts of present disclosure are not necessarily all referring to the same embodiment. Further, certain features, structures, or features of one or more embodiments of the present disclosure may be combined.

In addition, unless clearly stated in the claims, the order of processing elements and sequences, the use of numbers and letters, or the use of other names in the present disclosure are not used to limit the order of the procedures and methods of the present disclosure. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities of ingredients, properties, and so forth, used to describe and claim certain embodiments of the application are to be understood as being modified in some instances by the term “about,” “approximate,” or “substantially”. Unless otherwise stated, “about,” “approximate,” or “substantially” may indicate ±20% variation of the value it describes. Accordingly, in some embodiments, the numerical parameters used in the specification and claims are approximate values, and the approximation may change according to the characteristics required by the individual embodiments. In some embodiments, the numerical parameter should consider the prescribed effective digits and adopt a general digit retention method. Although in some embodiments, the numerical fields and parameters used to confirm the breadth of its range are approximate values, in specific embodiments, such numerical values are set as accurately as possible within the feasible range.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for monitoring a reliability of a self-closing valve for smart gas, the method comprising:
obtaining, in response to the gas self-closing valve being closed, operating environment data in a first preset time and gas usage information of a gas user in the first preset time;
determining a closure type of the gas self-closing valve based on the gas usage information and a setting position of the gas self-closing valve, the closure type including a first type, a second type, the first type being related to a gas usage situation, and the second type being related to a gas supply situation;
in response to the closure type being the first type, issuing an adjustment prompt; and
in response to the closure type being the second type, determining a reliability of a current closure state of the gas self-closing valve based at least on the operating environment data, and determining whether to issue an alert prompt based on the reliability.

2. The method of claim 1, wherein the determining a closure type of the gas self-closing valve based on the gas usage information and a setting position of the gas self-closing valve includes:
determining, in response to the setting position being a non-user position, the closure type to be the second type;
in response to the setting position being a user position,
determining whether the gas usage information satisfies a preset condition;
in response to the gas usage information satisfying the preset condition, determining the closure type to be the first type; and
in response to the gas usage information not satisfying the preset condition, determining the closure type to be the second type.

3. The method of claim 1, wherein the reliability includes a perceptual reliability, and the alert prompt includes a first alert prompt, the determining, in response to the closure type being the second type, a reliability of a current closure state of the gas self-closing valve based at least on the operating environment data, and the determining whether to issue an alert prompt based on the reliability, include:
in response to the closure type being the second type,
determining a gas supply feature based on the operating environment data;
determining the perceptual reliability of the current closure state based on the gas supply feature, and perceptual element data of the gas self-closing valve; and
issuing the first alert prompt to a manager in response to the perceptual reliability falling below a first reliability threshold.

4. The method of claim 3, wherein the determining the perceptual reliability of the current closure state based on the gas supply feature, and perceptual element data of the gas self-closing valve, includes:
determining a first perceptual reliability and/or a second perceptual reliability based on the gas supply feature and the perceptual element data; and
determining the perceptual reliability based on the first perceptual reliability and/or the second perceptual reliability.

5. The method of claim 4, wherein the determining a first perceptual reliability based on the gas supply feature and the perceptual element data includes:
determining a first abnormal degree based on the gas supply feature;
determining a second abnormal degree based on the perceptual element data;
determining a combined abnormal degree based on the first abnormal degree and the second abnormal degree; and
determining the first perceptual reliability based on the combined abnormal degree.

6. The method of claim 4, wherein the determining a second perceptual reliability based on the gas supply feature and the perceptual element data includes:
determining, based on the gas supply feature, the perceptual element data, and the operating environment data, a predicted failure rate of a perceptual element of the gas self-closing valve by a failure prediction model, the failure prediction model being a machine learning model; and
determining the second perceptual reliability based on the predicted failure rate.

7. The method of claim 6, wherein inputs of the failure prediction model further include a downstream gas supply interruption feature.

8. The method of claim 1, wherein the reliability includes an execution reliability and the alert prompt includes a second alert prompt, the determining, in response to the closure type being the second type, a reliability of a current closure state of the gas self-closing valve based at least on the operating environment data, and the determining whether to issue an alert prompt based on the reliability, includes:
in response to the closure type being the second type,
obtaining downstream gas data in a second preset time;
determining, based at least on the downstream gas data, a downstream gas supply interruption feature;
determining, based on the downstream gas supply interruption feature, the execution reliability; and
in response to the execution reliability falling below a second reliability threshold, issuing the second alert prompt to a manager.

9. The method of claim 8, wherein the second reliability threshold is related to a criticality of the setting position of the gas self-closing valve.

10. The method of claim 8, wherein the second reliability threshold is related to an overall performance score of a non-perceptual element of the gas self-closing valve.

11. An Internet of Things (IoT) system for monitoring a reliability of a self-closing valve for smart gas, wherein the IoT system comprises a smart gas user platform, a smart gas service platform, a smart gas equipment management platform, a smart gas sensing network platform, and a smart gas object platform interacting in sequence; the smart gas equipment management platform being configured to:
obtain, in response to the gas self-closing valve being closed, operating environment data in a first preset time and gas usage information of a gas user in the first preset time;
determine a closure type of the gas self-closing valve based on the gas usage information and a setting position of the gas self-closing valve, the closure type including a first type and a second type, the first type being related to a gas usage situation, and the second type being related to a gas supply situation;
in response to the closure type being the first type, issue an adjustment prompt; and
in response to the closure type being the second type, determine a reliability of a current closure state of the gas self-closing valve based at least on the operating environment data, and determine whether to issue an alert prompt based on the reliability.

12. The system of claim 11, wherein the smart gas equipment management platform is configured to:
determine, in response to the setting position being a non-user position, the closure type to be the second type;
in response to the setting position being a user position,
determine whether the gas usage information satisfies a preset condition;
in response to the gas usage information satisfying the preset condition, determine that the closure type to be the first type; and
in response to the gas usage information not satisfying the preset condition, determine the closure type to be the second type.

13. The system of claim 11, wherein the reliability includes a perceptual reliability, the alert prompt includes a first alert prompt, and the smart gas equipment management platform is configured to:
in response to the closure type being the second type,
determine a gas supply feature based on the operating environment data;
determine the perceptual reliability of the current closure state based on the gas supply feature, and perceptual element data of the gas self-closing valve; and
issue the first alert prompt to a manager in response to the perceptual reliability falling below a first reliability threshold.

14. The system of claim 13, wherein the smart gas equipment management platform is configured to:
determine a first perceptual reliability and/or a second perceptual reliability based on the gas supply feature and the perceptual element data; and
determine the perceptual reliability based on the first perceptual reliability and/or the second perceptual reliability.

15. The system of claim 14, wherein the smart gas equipment management platform is configured to:
determine a first abnormal degree based on the gas supply feature;
determine a second abnormal degree based on the perceptual element data;
determine a combined abnormal degree based on the first abnormal degree and the second abnormal degree; and
determine the first perceptual reliability based on the combined abnormal degree.

16. The system of claim 14, wherein the smart gas equipment management platform is configured to:
determine, based on the gas supply feature, the perceptual element data, and the operating environment data, a predicted failure rate of a perceptual element of the gas self-closing valve by a failure prediction model, the failure prediction model being a machine learning model; and
determine the second perceptual reliability based on the predicted failure rate.

17. The system of claim 16, wherein inputs of the failure prediction model further includes a downstream gas supply interruption feature.

18. The system of claim 11, wherein the reliability includes an execution reliability and the alert prompt includes a second alert prompt, the smart gas equipment management platform is configured to:
in response to the closure type being the second type,
obtain downstream gas data in a second preset time;
determine, based at least on the downstream gas data, a downstream gas supply interruption feature;
determine, based on the downstream gas supply interruption feature, the execution reliability; and
in response to the execution reliability falling below a second reliability threshold, issue the second alert prompt to a manager.

19. The system of claim 18, wherein the second reliability threshold is related to a criticality of the setting position of the gas self-closing valve.

20. The system of claim 18, wherein the second reliability threshold is related to an overall performance score of a non-perceptual element of the gas self-closing valve.
